(19) United States
(12) Patent Application Publication
(10) Pub. No.: US 2020/0048404 A1
(43) Pub. Date: Feb. 13, 2020

(54) PHOTO-CURABLE COMPOSITION, RESIN, BLOCKED ISOCYANATE, AND METHOD FOR MANUFACTURING THREE-DIMENSIONAL OBJECT

(71) Applicant: CANON KABUSHIKI KAISHA, Tokyo (JP)

(72) Inventor: Seiji Okada, Kawasaki-shi (JP)

(21) Appl. No.: 16/554,434

(22) Filed: Aug. 28, 2019

Related U.S. Application Data
(63) Continuation of application No. PCT/JP2018/007768, filed on Mar. 1, 2018.

(30) Foreign Application Priority Data
Mar. 3, 2017 (JP) 2017-040856
Jul. 19, 2017 (JP) 2017-140152

(51) Int. Cl. C08G 18/80; B29C 64/135; B29C 64/165; B29C 35/08; C08G 18/67

(52) U.S. Cl. CPC C08G 18/8058; B29C 64/135; B29C 64/165; B33Y 10/00; C08G 18/8048; C08G 18/673; B29C 35/0805

(57) ABSTRACT

A photo-curable composition includes a blocked isocyanate represented by the general formula (1):

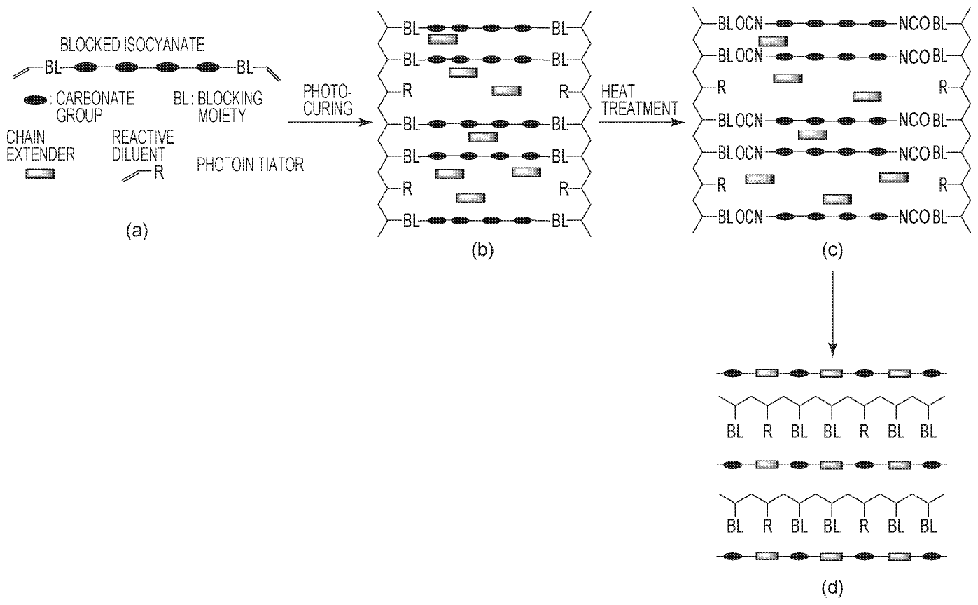

A-B-C (1)

(wherein, in the formula (1), A and C each independently represent a group represented by the formula (2) below, and B represents a group represented by the formula (3) below:

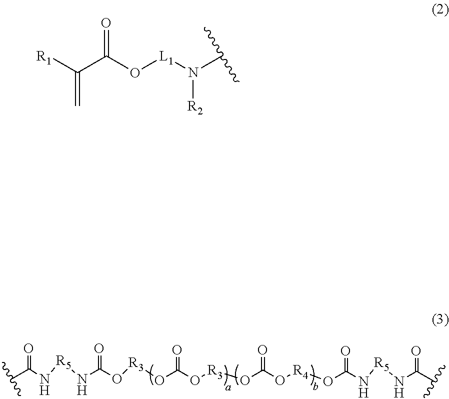

wherein, in the formula (2), R₁ represents a hydrogen atom or a methyl group, R₂ represents a hydrocarbon group which may have a substituent, and L₁ represents a divalent hydrocarbon group; and in the formula (3), R₃, R₄, and R₅ each independently represent a divalent hydrocarbon group which may have a substituent, 1≤a+b≤50).

### CROSS-REFERENCE TO RELATED APPLICATIONS

This application is a Continuation of International Patent Application No. PCT/JP2018/007768, filed Mar. 1, 2018, which claims the benefit of Japanese Patent Application No. 2017-040856, filed Mar. 3, 2017 and Japanese Patent Application No. 2017-140152, filed Jul. 19, 2017, all of which are hereby incorporated by reference herein in their entirety.

### TECHNICAL FIELD

The present invention relates to a photo-curable composition, a resin, a blocked isocyanate, and a method for manufacturing a three-dimensional object.

### BACKGROUND ART

A stereolithographic fabrication process (stereolithography), in which a liquid photo-curable composition is cured, layer by layer, with light, such as ultraviolet light, and the cured layers are successively laminated to fabricate a desired three-dimensional object, has been thoroughly studied. The applications of stereolithography have expanded to include not only the creation of prototypes for confirming shapes (rapid prototyping), but also the creation of working models and the creation of molds for verifying functionality (rapid tooling). Furthermore, the applications of stereolithography are expanding to include the creation of actual products (rapid manufacturing).

Under such a background, requirements for photo-curable compositions used in stereolithography are enhanced, and there is a demand for photo-curable compositions capable of creating a three-dimensional object having high mechanical properties (rigidity, strength, and the like) comparable to those of general-purpose engineering plastics.

International Publication No. 2015/200201 (Patent Literature 1) describes a method of creating a three-dimensional object, in which, using a photo-curable composition including an acrylic group-containing blocked isocyanate and a chain extender, creation of an object by stereolithography (photo-curing) is performed, and the resulting photo-cured product is further subjected to heat treatment. According to the method described in Patent Literature 1, a three-dimensional object having rigidity, strength, toughness, and the like in a well-balanced manner can be obtained.

### CITATION LIST

### Patent Literature

PTL 1 International Publication No. 2015/200201

In the photo-curable composition described in Patent Literature 1, by performing heat treatment after photo-curing, tensile strength (strength) can be increased compared to existing photo-curable compositions, such as urethane acrylate-based photo-curable compositions. However, improvement in modulus of elasticity (rigidity) is insufficient.

The present invention provides a photo-curable composition capable of creating a three-dimensional object having a high tensile strength and a high modulus of elasticity.

### SUMMARY OF INVENTION

A photo-curable composition according to an aspect of the present invention includes a blocked isocyanate, a chain extender, and a photo-radical generator, in which the blocked isocyanate is represented by the general formula (1):

A-B-C (1)

(wherein, in the formula (1), A and C each independently represent a group represented by the formula (2) below, and B represents a group represented by the formula (3) below:

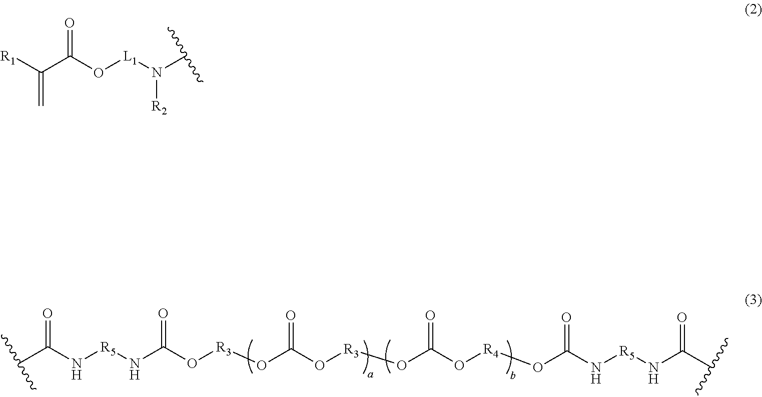

wherein, in the formula (2), R₁ represents a hydrogen atom or a methyl group, R₂ represents a hydrocarbon group having 1 to 10 carbon atoms which may have a substituent, and L₁ represents a divalent hydrocarbon group having 1 to 10 carbon atoms; and in the formula (3), R₃, R₄, and R₅ each independently represent a divalent hydrocarbon group having 1 to 20 carbon atoms which may have a substituent, a and b are integers satisfying 1≤a+b≤50, and a or b may be 0).

Further features of the present invention will become apparent from the following description of exemplary embodiments with reference to the attached drawing.

### BRIEF DESCRIPTION OF DRAWING

FIGURE is a view schematically illustrating a reaction scheme when a photo-curable composition according to an embodiment of the present invention is cured by irradiation with light, and is then subjected to heat treatment.

### DESCRIPTION OF EMBODIMENTS

The embodiments of the present invention will be described below. It should be understood that the present invention is not limited to the embodiments described below, and embodiments obtained by, for example, appropriately changing or improving the embodiments without departing from the gist of the present invention based on the ordinary knowledge of those skilled in the art are also included in the scope of the present invention.

### First Embodiment

A photo-curable composition according to a first embodiment includes a blocked isocyanate (a), a chain extender (b), and a photo-radical generator (c).

The components included in the photo-curable composition according to this embodiment will be described in detail below.

[Blocked Isocyanate (a)]

The blocked isocyanate (a) is represented by the general formula (1):

A-B-C (1)

(wherein, in the formula (1), A and C each independently represent a group represented by the formula (2) below, and B represents a group represented by the formula (3) below:

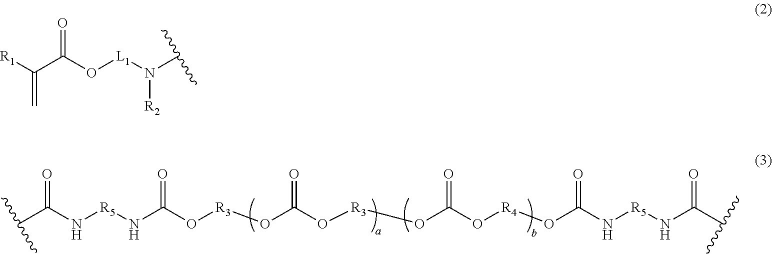

wherein, in the formula (2), R₁ represents a hydrogen atom or a methyl group, R₂ represents a hydrocarbon group having 1 to 10 carbon atoms which may have a substituent, and L₁ represents a divalent hydrocarbon group having 1 to 10 carbon atoms which may have a substituent; and in the formula (3), R₃, R₄, and R₅ each independently represent a divalent hydrocarbon group having 1 to 20 carbon atoms which may have a substituent, a and b are integers satisfying 1≤a+b≤50, and a or b may be 0).

As described above, the blocked isocyanate (a) is a (meth)acrylic compound having at least two (meth)acryloyl groups. The term “(meth)acryloyl group” as used herein means an acryloyl group or a methacryloyl group, and the term “(meth)acrylic compound” as used herein means an acrylic compound or a methacrylic compound. The (meth)acryloyl group is a polymerizable functional group, and the blocked isocyanate (a) is polymerized by a radical generated by a photo-radical generator (c), which will be described later.

In the formula (2) and the formula (3), in the case where any one of L₁, R₂, R₃, R₄, and R₅ has a substituent, the substituent may be a substituent containing a carbon atom. However, in such a case, the atom of the substituent which is bonded to each of L₁, R₂, R₃, R₄, and R₅ is an atom other than the carbon atom. Furthermore, in such a case, the number of carbon atoms contained in the substituent is not included in the number of carbon atoms of the “hydrocarbon group”.

In the formula (2), R₂ is preferably a group selected from a ter-butyl group, a ter-pentyl group, and a ter-hexyl group. This is preferred because it is possible to lower the temperature (deblocking temperature) at which deblocking is performed by subjecting the photo-curable composition which has been photo-cured to heat treatment. Furthermore, when any one of the groups described above is employed as R₂, the blocked isocyanate (a) can be synthesized easily. Furthermore, when any one of the groups described above is employed as R₂, the blocked isocyanate (a) can be synthesized at low cost.

In the formula (2), L₁ is preferably an ethylene group or a propylene group from the viewpoint of availability and ease of synthesis.

In the formula (3), R₃ and R₄ are preferably each independently any one of the groups represented by the formulae (A-1) to (A-9) below. In this case, as will be described later, it is possible to further increase the modulus of elasticity and tensile strength of a cured product obtained by subjecting the photo-curable composition which has been photo-cured to heat treatment.

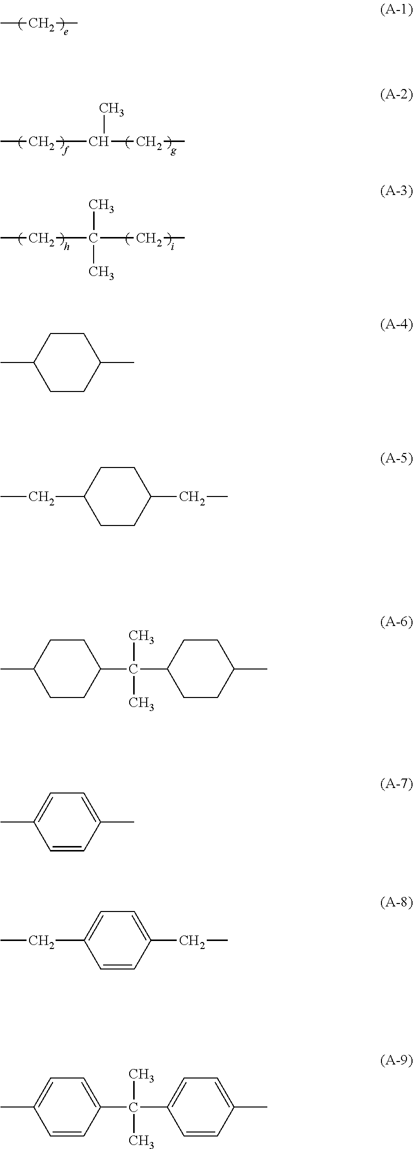

In the formula (A-1), e is an integer of 1 to 10, and in the formula (A-2), f and g are integers satisfying 1≤f+g≤10, and f or g may be 0. Furthermore, in the formula (A-3), h and i are integers satisfying 1≤h+i≤10, and h or i may be 0.

Furthermore, in the formula (1), A and C are preferably identical to each other. That is, the blocked isocyanate (a) is preferably represented by the general formula (4) below. In this case, the blocked isocyanate (a) can be synthesized easily at low cost.

A-B-A (4)

(wherein, in the formula (4), A represents a group represented by the formula (2), and B represents a group represented by the formula (3)).

Specific structures of the blocked isocyanate (a) are exemplified below.

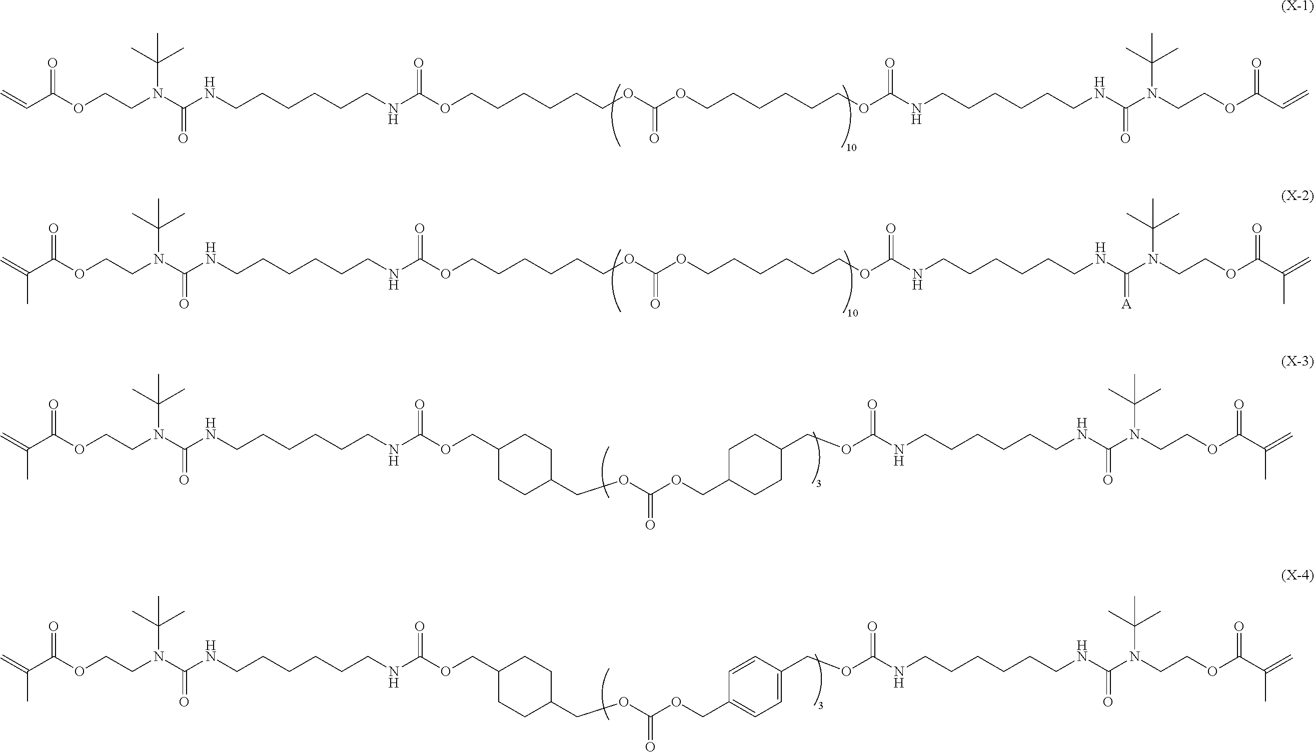

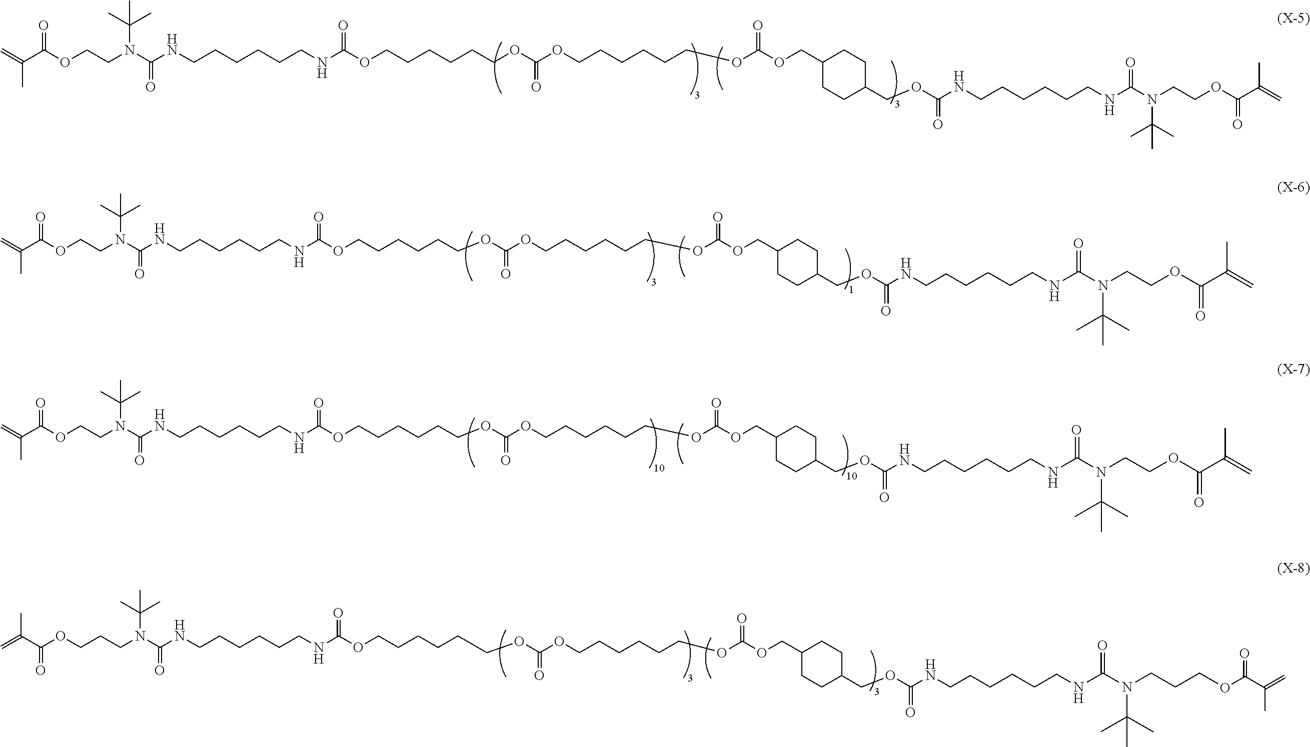

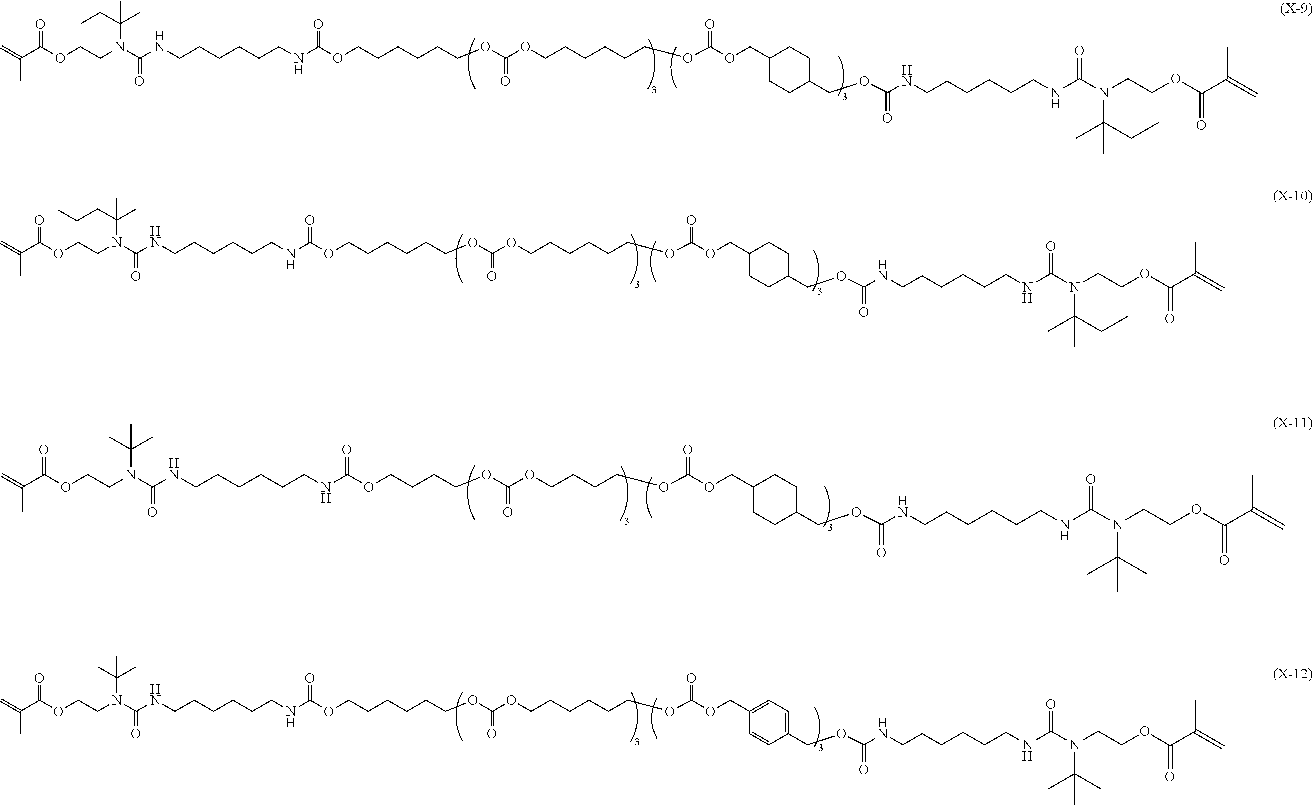

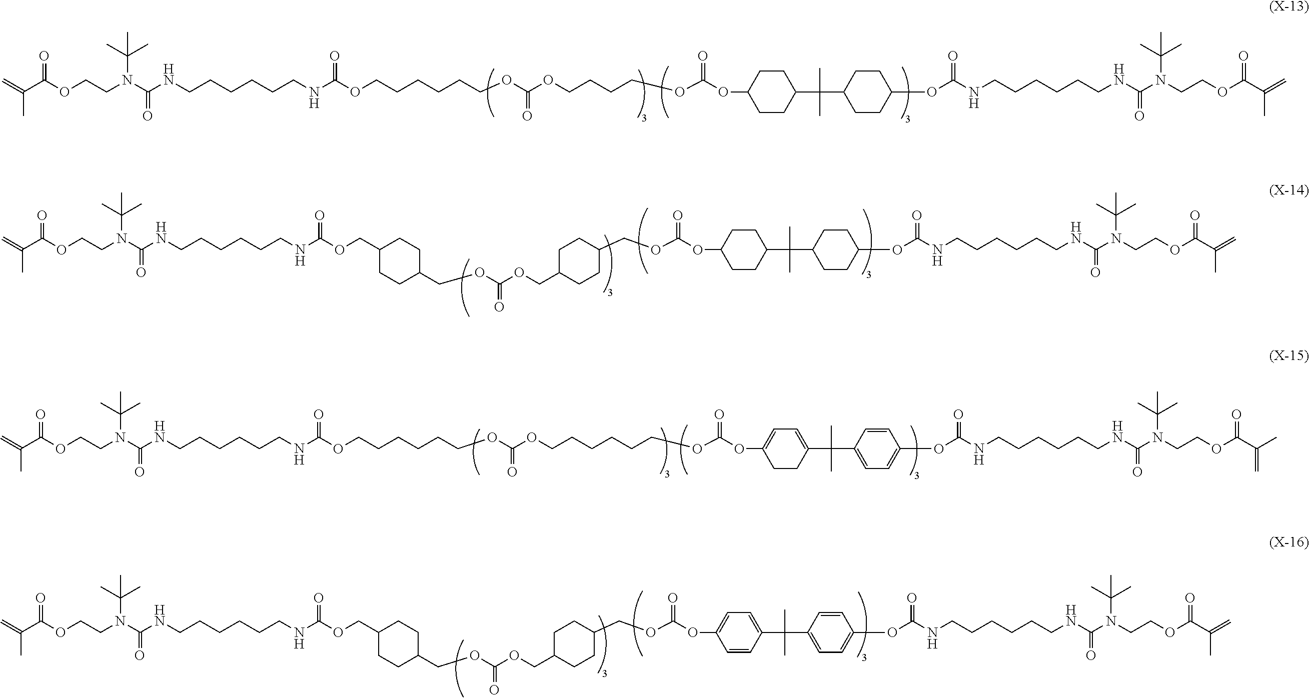

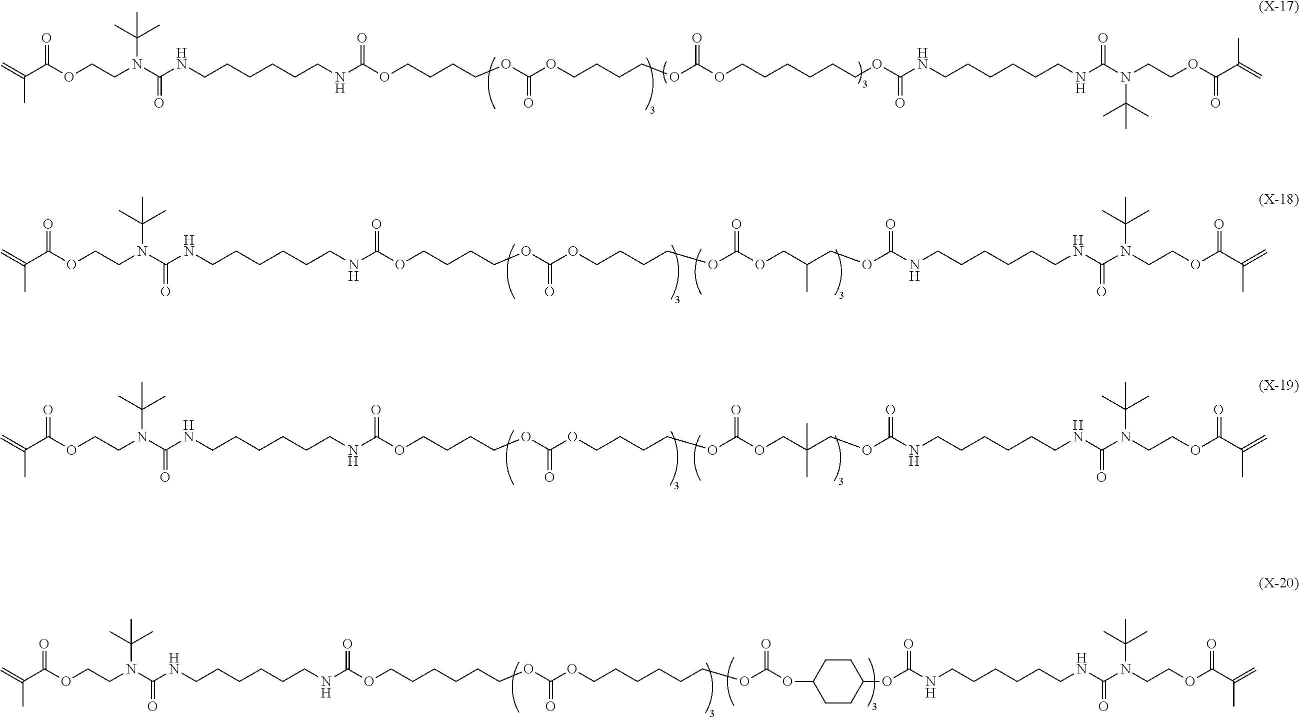

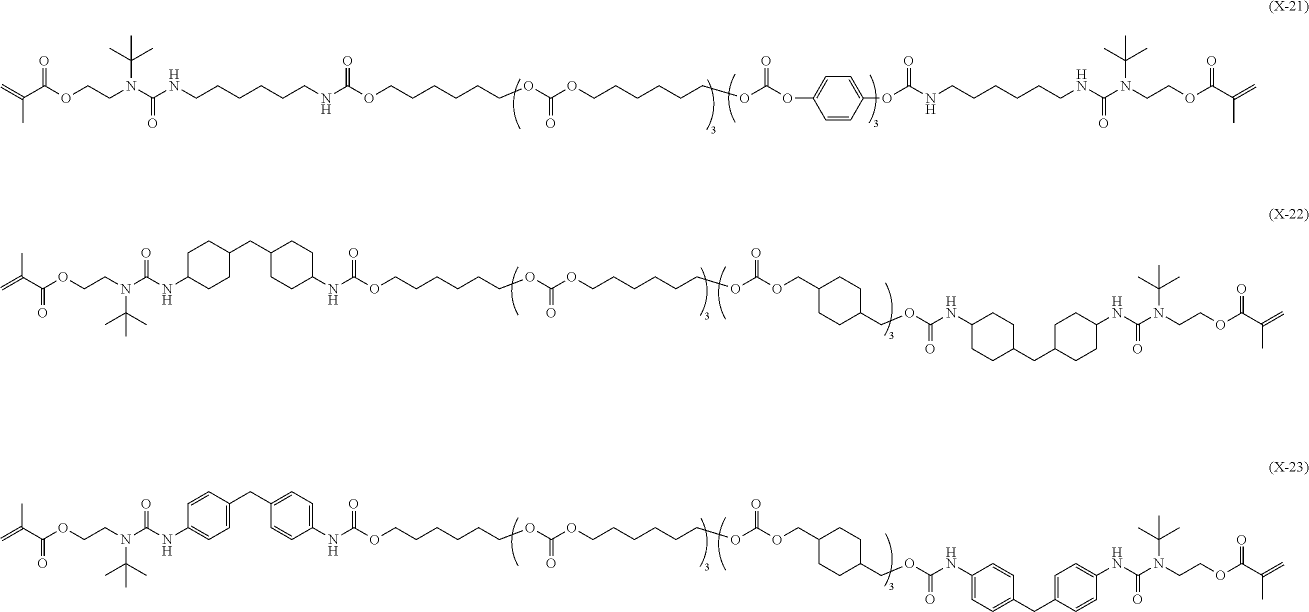

As the blocked isocyanate (a) to be included in the photo-curable composition, one or a plurality of compounds may be used. When a plurality of compounds are included as the blocked isocyanate (a), the mixing ratio of the blocked isocyanate (a) in the photo-curable composition is calculated on the basis of a total mass of the plurality of compounds.

The mixing ratio of the blocked isocyanate (a) in the photo-curable composition is preferably 10% by mass or more and 90% by mass or less, and more preferably 30% by mass or more and 70% by mass or less relative to the entire photo-curable composition as 100% by mass. When the mixing ratio is less than 10% by mass, the toughness of a cured product obtained by curing the photo-curable composition is decreased. When the mixing ratio is more than 90% by mass, the viscosity of the photo-curable composition is increased, and handling becomes difficult.

<Synthesis Method for Blocked Isocyanate (a)>

A synthesis method for the blocked isocyanate (a) will now be described. The synthesis method for the blocked isocyanate (a) includes step (I) and step (II) described below.

Step (I): a step of reacting a polycarbonate diol with a diisocyanate

Step (II): a step of reacting a blocking agent with a diisocyanate having a polycarbonate skeleton obtained in step (I)

Each of the steps will be described below.

(Step (I): step of reacting polycarbonate diol with diisocyanate)

This step is a step of reacting a polycarbonate diol with a diisocyanate. As a result of this, a diisocyanate having a polycarbonate skeleton is obtained.

The polycarbonate diol used in this step can be synthesized, for example, by an ester exchange reaction between a carbonate compound and a diol.

Examples of the carbonate compound to be used to synthesize the polycarbonate diol include, but are not limited to, dialkyl carbonates, such as dimethyl carbonate and diethyl carbonate; alkylene carbonates, such as ethylene carbonate and propylene carbonate; and diaryl carbonates, such as diphenyl carbonate, dinaphthyl carbonate, dianthryl carbonate, diphenanthryl carbonate, diindanyl carbonate, and tetrahydronaphthyl carbonate. These carbonate compounds may be used as a mixture of two or more.

Examples of the diol to be used to synthesize the polycarbonate diol include, but are not limited to, aliphatic diols, such as ethylene glycol, diethylene glycol, propylene glycol, 1,4-butanediol, 1,3-butanediol, 1,5-pentanediol, neopentyl glycol, 3-methyl-1,5-pentanediol, 1,6-hexanediol, 1,4-cyclohexanedimethanol, 2-methyl-1,8-octanediol, and 1,9-nonanediol; alicyclic diols, such as cyclohexanediol, hydrogenated bisphenol-A, hydrogenated bisphenol-F, and hydrogenated xylylene glycol; and aromatic diols, such as bisphenol A, bisphenol F, 4,4′-biphenol, and xylylene glycol. These diols may be used as a mixture of two or more.

The polycarbonate diol preferably has a number-average molecular weight Mₙ of 100 or more and 5,000 or less. When the polycarbonate diol has a number-average molecular weight Mₙ of less than 100, the molecular weight of the finally obtained blocked isocyanate is decreased, and as a result, the modulus of elasticity and tensile strength of a three-dimensional object obtained by curing the photo-curable composition may be decreased in some cases. Furthermore, when the polycarbonate diol has a number-average molecular weight Mₙ of more than 5,000, the molecular weight of the finally obtained blocked isocyanate is increased. As a result, the viscosity of the photo-curable composition is increased, and workability may be decreased in some cases.

Examples of a commercially available product of the polycarbonate diol include, but are not limited to, ETERNACOLL UM-90(3/1) (Mₙ=900), ETERNACOLL UM-90(1/1) (Mₙ=900), ETERNACOLL UM-90(1/3) (Mₙ=900), ETERNACOLL UC-100 (Mₙ=1,000), ETERNACOLL UH-200 (Mₙ=2,000), ETERNACOLL UH-100 (Mₙ=1,000), ETERNACOLL PH-200 (Mₙ=2,000), and ETERNACOLL PH-100 (Mₙ=1,000) (all of which are manufactured by Ube Industries, Ltd).

Examples of the diisocyanate to be used in this step include, but are not limited to, aliphatic diisocyanates, such as trimethylene diisocyanate, 1,2-propylene diisocyanate, butylene diisocyanate, hexamethylene diisocyanate, pentamethylene diisocyanate, and trimethylhexamethylene diisocyanate; alicyclic diisocyanates, such as cyclohexane diisocyanate, methylcyclohexane diisocyanate, 3-isocyanatomethyl-3,5,5-trimethylcyclohexyl isocyanate (isophorone diisocyanate), methylenebis(cyclohexyl isocyanate) or dicyclohexylmethane diisocyanate, bis(isocyanatomethyl)cyclohexane, and norbornane diisocyanate; and aromatic diisocyanates, such as phenylene diisocyanate, tolylene diisocyanate, 4,4′-diphenyl diisocyanate, 1,5-naphthalene diisocyanate, diphenylmethane diisocyanate, and 4,4′-toluidine diisocyanate.

In this step, preferably, the polycarbonate diol is reacted with the diisocyanate in a solvent. The solvent is not particularly limited as long as the polycarbonate diol and the diisocyanate are dissolved therein. Specific examples thereof include dialkyl ethers, such as diethyl ether and dipropyl ether; cyclic ethers, such as 1,4-dioxane and tetrahydrofuran; ketones, such as acetone, methyl ethyl ketone, diisopropyl ketone, and isobutyl methyl ketone; esters, such as methyl acetate, ethyl acetate, and butyl acetate; hydrocarbons, such as toluene, xylene, and ethylbenzene; halogen-based solvents, such as methylene chloride, chloroform, carbon tetrachloride, tetrachloroethane, trichloroethane, and chlorobenzene; and nitriles, such as acetonitrile. These solvents may be used alone or in combination of two or more. Furthermore, as the solvent, a dehydrated solvent is preferably used from the viewpoint of suppressing decomposition of isocyanate groups of the diisocyanate compound due to water.

The ratio of the number of moles of the diisocyanate to the number of moles of the polycarbonate diol to be reacted in this step (number of moles of the diisocyanate/number of moles of the polycarbonate diol) is preferably 1 or more and 20 or less, and more preferably 3 or more and 10 or less. When the ratio is less than 1, formation of polyurethane by polyaddition reaction between the diisocyanate and the polycarbonate diol, which is a side reaction, occurs at a high rate, and the yield of the target diisocyanate having a polycarbonate skeleton is decreased. When the ratio is more than 20, the diisocyanate remains unreacted excessively after the reaction, and it may become difficult to remove the unreacted diisocyanate in some cases.

This step is preferably performed in an inert atmosphere, such as nitrogen, helium, or argon. Furthermore, this step is performed preferably at 0° C. or higher and 150° C. or lower, and more preferably at 30° C. or higher and 100° C. or lower. Furthermore, this step may be performed under reflux. When this step is performed at a reaction temperature of higher than 150° C., there is an increased possibility of occurrence of a side reaction. When this step is performed at a reaction temperature of lower than 0° C., the reaction rate is decreased, and therefore, the reaction time is prolonged or the yield is decreased.

This step may be performed in the presence of a catalyst. Examples of the catalyst include organic tin-based compounds, such as tin octylate, dibutyltin diacetate, dibutyltin dilaurate, and tin 2-ethylhexanoate; naphthenic acid metal salts, such as copper naphthenate, zinc naphthenate, and cobalt naphthenate; and tertiary amines, such as triethylamine, benzyldimethylamine, pyridine, N,N-dimethylpiperazine, and triethylenediamine. These catalysts may be used alone or in combination of two or more. The amount of the catalyst to be used may be 0.001% by mass or more and 1% by mass or less relative to the total amount (100% by mass) of the polycarbonate diol.

The diisocyanate having a polycarbonate skeleton obtained by this step can be separated and purified by a commonly used separation method, for example, separation means, such as reprecipitation with a poor solvent, concentration, or filtration, or combined separation means thereof.

(Step (II): step of reacting blocking agent with diisocyanate having polycarbonate skeleton obtained in step (I))

This step is a step of reacting a blocking agent with a diisocyanate having a polycarbonate skeleton obtained in step (I). As a result of this, a blocked isocyanate (a) according to this embodiment is obtained.

The term “blocking agent” as used herein means a compound which can react with an isocyanate group (—NCO) of the diisocyanate to protect the active isocyanate group. The isocyanate group protected with the blocking agent is referred to as a blocked isocyanate group. The blocked isocyanate group is protected with the blocking agent, and therefore, can remain stable under normal conditions.

When a blocked isocyanate compound having a blocked isocyanate group is heated, the blocking agent is dissociated from the blocked isocyanate group (deblocking occurs), and the original isocyanate group can be regenerated.

The blocking agent to be used in this step is not particularly limited as long as the blocking agent is a (meth)acrylic compound having an amino group, but is preferably a compound selected from ter-butylaminoethyl (meth)acrylate, ter-pentylaminoethyl (meth)acrylate, ter-hexylaminoethyl (meth)acrylate, and ter-butylaminopropyl (meth)acrylate. In this case, the deblocking temperature of the blocked isocyanate can be decreased.

In this step, preferably, the blocking agent is reacted with the diisocyanate having a polycarbonate skeleton in a solvent. The solvent is not particularly limited as long as the blocking agent and the diisocyanate having a polycarbonate skeleton are dissolved therein. Specifically, the solvents described in step (I) may be used.

This step is preferably performed in an inert atmosphere, such as nitrogen, helium, or argon. Furthermore, this step is performed preferably at 0° C. or higher and 150° C. or lower, and more preferably at 30° C. or higher and 80° C. or lower. Furthermore, this step may be performed under reflux. When this step is performed at a reaction temperature of lower than 0° C., the reaction is unlikely to proceed. When this step is performed at a reaction temperature of higher than 150° C., there is a concern that blocking agent molecules may be polymerized with each other through polymerization of (meth)acryloyl groups.

This step may be performed in the presence of a catalyst. Specifically, the catalysts described in step (I) may be used.

Furthermore, in this step, a polymerization inhibitor may be used for the purpose of inhibiting polymerization of (meth)acryloyl groups of the blocking agent. Specific examples thereof include benzoquinone, hydroquinone, catechol, diphenyl benzoquinone, hydroquinone monomethyl ether, naphthoquinone, t-butylcatechol, t-butylphenol, dimethyl-t-butylphenol, t-butylcresol, dibutylhydroxytoluene, and phenothiazine.

The blocked isocyanate obtained by this step can be separated and purified in the same manner as in step (I).

[Chain Extender (b)]

The chain extender (b) is a compound having at least two active hydrogens, each of which reacts with an isocyanate group formed by deblocking of the blocked isocyanate group in the blocked isocyanate (a).

Examples of an active hydrogen which reacts with an isocyanate group include a hydrogen atom of a hydroxyl group, a hydrogen atom of an amino group, and a hydrogen atom of a thiol group. Accordingly, the chain extender (b) preferably includes a compound having, in its molecule, at least two functional groups selected from the group consisting of a hydroxyl group, an amino group, and a thiol group. Furthermore, from the viewpoint of reactivity, the chain extender (b) more preferably includes at least one selected from the group consisting of a polyol having at least two hydroxyl groups, a polyamine having at least two amino groups, and a polythiol having at least two thiol groups.

Furthermore, the chain extender (b) is preferably a low molecular weight compound. The chain extender (b) has a molecular weight of preferably 500 or less, and more preferably 300 or less. When the chain extender (b) has a molecular weight of 500 or less, as will be described later, the chain extender (b) can efficiently react with isocyanate groups generated by deblocking when the photo-curable composition which has been photo-cured is subjected to heat treatment.

Specific examples of the chain extender (b) include linear diols, such as ethylene glycol, 1,3-propanediol, 1,4-butanediol, 1,5-pentanediol, 1,6-hexanediol, 1,8-octanediol, 1,9-nonanediol, and 1,10-decanediol; branched-chain diols, such as 2-methyl-1,3-propanediol, 2,2-dimethyl-1,3-propanediol, 2,2-diethyl-1,3-propanediol, 2-methyl-2-propyl-1,3-propanediol, 2,4-heptanediol, 1,4-dimethylolhexane, 2-ethyl-1,3-hexanediol, 2,2,4-trimethyl-1,3-pentanediol, 2-methyl-1,8-octanediol, 2-butyl-2-ethyl-1,3-propanediol, and dimer diols; ether group-containing diols, such as diethylene glycol and propylene glycol; diols having an alicyclic structure, such as 1,4-cyclohexanediol, 1,4-cyclohexanedimethanol, and 1,4-dihydroxyethylcyclohexane; aromatic group-containing diols, such as xylylene glycol, 1,4-dihydroxyethylbenzene, and 4,4′-methylenebis(hydroxyethylbenzene); polyols, such as glycerin, trimethylolpropane, and pentaerythritol; hydroxyamines, such as N-methylethanolamine and N-ethylethanolamine; polyamines, such as ethylenediamine, 1,3-diaminopropane, hexamethylenediamine, triethylenetetramine, diethylenetriamine, isophoronediamine, 4,4′-diaminodicyclohexylmethane, 2-hydroxyethylpropylenediamine, di-2-hydroxyethylethylenediamine, di-2-hydroxyethylpropylenediamine, 2-hydroxypropylethylenediamine, di-2-hydroxypropylethylenediamine, 4,4′-diphenylmethanediamine, methylenebis(o-chloroaniline), xylylenediamine, diphenyldiamine, tolylenediamine, hydrazine, piperazine, and N,N′-diaminopiperazine; aliphatic polythiols, such as 1,2-ethanedithiol, 1,2,3-propanetrithiol, 1,2-cyclohexanedithiol, bis(2-mercaptoethyl) ether, tetrakis(mercaptomethyl)methane, diethylene glycol bis(2-mercaptoacetate), trimethylolpropane tris(3-mercaptopropionate), trimethylolpropane tris(2-mercaptoacetate), pentaerythritol tetrakis(2-mercaptoacetate), pentaerythritol tetrakis(3-mercaptopropionate), hydroxymethyl sulfide bis(2-mercaptoacetate), hydroxymethyl sulfide bis(3-mercaptopropionate), 1,1,3,3-tetrakis(mercaptomethylthio)propane, and tris(mercaptoethylthio)methane; aromatic polythiol compounds, such as 1,2-dimercaptobenzene, 1,3-dimercaptobenzene, 1,4-dimercaptobenzene, 1,2-bis(mercaptomethyl)benzene, 1,3-bis(mercaptomethyl)benzene, 1,4-bis(mercaptomethyl)benzene, 1,2-bis(mercaptoethyl)benzene, 1,3-bis(mercaptoethyl)benzene, 1,4-bis(mercaptoethyl)benzene, 1,3,5-trimercaptobenzene, 1,3,5-tris(mercaptomethyl)benzene, 1,3,5-tris(mercaptomethyleneoxy)benzene, 1,3,5-tris(mercaptoethyleneoxy)benzene, 2,5-toluenedithiol, 3,4-toluenedithiol, 1,5-naphthalenedithiol, and 2,6-naphthalenedithiol; and water. These chain extenders may be used alone or in combination of two or more.

Among these, preferred are 1,4-butanediol, 1,5-pentanediol, 1,6-hexanediol, 1,8-octanediol, 1,9-nonanediol, 1,10-decanediol, 1,4-cyclohexanedimethanol, 1,4-dihydroxyethylcyclohexane, ethylenediamine, 1,3-diaminopropane, isophoronediamine, and 4,4′-diaminodicyclohexylmethane from the viewpoint that physical properties of a cured product, which will be described later, are suitably balanced, and they are industrially inexpensively available in large amounts.

The ratio of the number of moles of the chain extender (b) to the number of moles of the blocked isocyanate (a) (number of moles of the chain extender (b)/number of moles of blocked isocyanate (a)), is preferably 0.1 or more and 5 or less, and more preferably 0.5 or more and 3 or less. As will be described later, when the photo-curable composition according to this embodiment is photo-cured and is then subjected to heat treatment, the isocyanate group is regenerated, which causes a reaction that forms a bond, such as a urethane bond, between the isocyanate group and the chain extender (b). However, when the ratio is less than 0.1, the efficiency of the reaction between the isocyanate group and the chain extender (b) decreases, and various mechanical properties of a three-dimensional object finally obtained by photo-curing and subsequent heat treatment tend to be lowered. When the ratio is more than 5, the chain extender (b) remains unreacted excessively in a three-dimensional object, and various mechanical properties of a three-dimensional object finally obtained by photo-curing and subsequent heat treatment tend to be lowered.

[Photo-Radical Generator (c)]

The photo-radical generator (c) is a compound that generates a radical, which is a factor of polymerization, when irradiated with an active energy ray, such as light having a predetermined wavelength. The photo-radical generator (c) may be a compound that is decomposed to generate a radical when irradiated with an active energy ray. Specifically, the photo-radical generator is a photopolymerization initiator that generates a radical when irradiated with an active energy ray, such as light (e.g., infrared light, visible light, ultraviolet light, far-ultraviolet light, an X-ray, a charged particle beam, such as an electron beam, or radiation).

Specific examples of the photo-radical generator (c) include, but are not limited to, carbonyl compounds, such as benzoin, benzoin monomethyl ether, benzoin isopropyl ether, acetoin, benzyl, benzophenone, p-methoxybenzophenone, diethoxyacetophenone, benzyl dimethyl ketal, 2,2-diethoxyacetophenone, 1-hydroxycyclohexyl phenyl ketone, methyl phenylglyoxylate, ethyl phenylglyoxylate, and 2-hydroxy-2-methyl-1-phenylpropan-1-one; sulfur compounds, such as tetramethylthiuram monosulfide and tetramethylthiuram disulfide; and acylphosphine oxides, such as 2,4,6-trimethylbenzoyl diphenylphosphine oxide.

Examples of commercially available products of the photo-radical generator include, but are not limited to, IRGACURE series, such as IRGACURE 184 and IRGACURE 819, and DAROCUR series, such as DAROCUR 1173 and DAROCUR TPO (all of which are manufactured by BASF); and KAYACURE series, such as KAYACURE DETX-S and KAYACURE CTX (all of which are manufactured by Nippon Kayaku Co., Ltd).

The addition amount of the photo-radical generator is preferably 0.05% by mass or more and 20% by mass or less, and more preferably 0.1% by mass or more and 5% by mass or less relative to the entire photo-curable composition as 100% by mass. When the addition amount is less than 0.05% by mass, the amount of radical generated becomes insufficient, and the polymerization conversion rate of the photo-curable composition decreases. As a result, the strength of a three-dimensional object obtained by subjecting the photo-curable composition which has been photo-cured to heat treatment becomes insufficient. When the addition amount is more than 30% by mass, most of the light radiated to the photo-curable composition is absorbed by the photo-radical generator (c) which exists excessively, and the light may not reach an inside of the curable composition in some cases. Therefore, there is a concern that the polymerization conversion rate of the photo-curable composition in the inside of the photo-curable composition may be decreased.

[Other Components]

(Reactive Diluent (d))

The photo-curable composition according to this embodiment may further include a reactive diluent (d). By incorporating the reactive diluent (d) into the photo-curable composition, the viscosity of the photo-curable composition can be decreased. Furthermore, the mechanical properties and thermal properties of a cured product obtained by curing the photo-curable composition can be adjusted.

The reactive diluent (d) is preferably a monomer and/or an oligomer having a radically and/or cationically polymerizable group.

Examples of the monomer having a radically polymerizable group include a (meth)acrylate-based monomer, a styrene-based monomer, acrylonitrile, a vinyl ester-based monomer, N-vinylpyrrolidone, an acrylamide-based monomer, a conjugated diene-based monomer, a vinyl ketone-based monomer, and a vinyl halide- or vinylidene halide-based monomer.

Examples of the monomer having a cationically polymerizable group include an epoxy-based monomer, an oxetane-based monomer, and a vinyl ether-based monomer.

In particular, among the monomers having a radically polymerizable group, preferred is a (meth)acrylate-based monomer having the same (meth)acryloyl group as that of the blocked isocyanate (a). Examples of the (meth)acrylate-based monomer include a monofunctional (meth)acrylate, a difunctional (meth)acrylate, a tri- or more functional (meth)acrylate, a urethane (meth)acrylate oligomer, and a polyester (meth)acrylate oligomer.

Examples of the (meth)acrylate-based monomer include monofunctional (meth)acrylates, such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, iso-octyl (meth)acrylate, 2-ethylhexyl (meth)acrylate, nonyl (meth)acrylate, isononyl (meth)acrylate, decyl (meth)acrylate, isodecyl (meth)acrylate, dodecyl (meth)acrylate, lauryl (meth)acrylate, stearyl (meth)acrylate, tridecyl (meth)acrylate, cyclohexyl (meth)acrylate, isobornyl (meth)acrylate, dicyclopentanyl (meth)acrylate, adamantyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, and stearyl (meth)acrylate; difunctional (meth)acrylates, such as 1,4-butanediol di(meth)acrylate, 1,6-hexanediol di(meth)acrylate, 1,9-nonanediol di(meth)acrylate, tricyclodecanedimethanol di(meth)acrylate, bisphenol A (poly)ethoxy di(meth)acrylate, bisphenol A (poly)propoxy di(meth)acrylate, bisphenol F (poly)ethoxy di(meth)acrylate, and ethylene glycol di(meth)acrylate; and tri- or more functional (meth)acrylates, such as ditrimethylolpropane tetra(meth)acrylate, trimethylolpropane tri(meth)acrylate, trimethyloloctane tri(meth)acrylate, trimethylolpropane polyethoxy tri(meth)acrylate, trimethylolpropane (poly)propoxy tri(meth)acrylate, trimethylolpropane (poly)ethoxy (poly)propoxy tri(meth)acrylate, pentaerythritol tri(meth)acrylate, pentaerythritol polyethoxy tetra(meth)acrylate, pentaerythritol (poly)propoxy tetra(meth)acrylate, pentaerythritol tetra(meth)acrylate, dipentaerythritol tetra(meth)acrylate, dipentaerythritol penta(meth)acrylate, dipentaerythritol hexa(meth)acrylate, tris[(meth)acryloyloxyethyl]isocyanurate, and caprolactone-modified tris[(meth)acryloyloxyethyl]isocyanurate.

Examples of the urethane (meth)acrylate oligomer include, but are not limited to, a polycarbonate-based urethane (meth)acrylate, a polyester-based urethane (meth)acrylate, a polyether-based urethane (meth)acrylate, and a caprolactone-based urethane (meth)acrylate. The urethane (meth)acrylate oligomer may be obtained, for example, by a reaction between an isocyanate compound, which is obtained by reacting a polyol with a diisocyanate, and a (meth)acrylate monomer having a hydroxyl group. Examples of the polyol include a polycarbonate diol, a polyester polyol, a polyether polyol, and a polycaprolactone polyol.

The polyester acrylate oligomer is obtained, for example, by obtaining a polyester oligomer having hydroxyl groups at both ends by condensation between a polycarboxylic acid and a polyol, and then esterifying the hydroxyl groups at both ends with acrylic acid.

The reactive diluent (d) may be added in any amount as long as the effects of the present invention are not impaired, so that the viscosity and the curing rate of the photo-curable composition and the mechanical and thermal properties of the cured product can be set to desired values.

(Photo-Acid Generator (e))

The photo-curable composition according to this embodiment may further include a photo-acid generator (e) in the case where the photo-curable composition includes a monomer or oligomer having a cationically polymerizable group as the reactive diluent (d).

Specific examples of the photo-acid generator (e) include, but are not limited to, a trichloromethyl-s-triazine, a sulfonium salt, an iodonium salt, a quaternary ammonium salt, a diazomethane compound, an imidosulfonate compound, and an oxime sulfonate compound.

(Other Additives)

Furthermore, as long as the effects of the present invention are not impaired, the photo-curable composition according to this embodiment may include, as necessary, one or two or more additives selected from, for example, a colorant, such as a pigment or a dye, an antifoaming agent, a leveling agent, a thickener, a flame retardant, an antioxidant, an inorganic filler (cross-linked polymer particles, silica, glass powder, ceramic powder, metal powder, or the like), and a modifier resin (a thermoplastic resin, thermoplastic resin particles, rubber particles, or the like) in an appropriate amount.

Furthermore, the photo-curable composition according to this embodiment may include, as necessary, in addition to the photo-radical generator (c), a photoinitiation auxiliary or a sensitizer. Examples of the photoinitiation auxiliary or the sensitizer include, but are not limited to, a benzoin compound, an acetophenone compound, an anthraquinone compound, a thioxanthone compound, a ketal compound, a benzophenone compound, a tertiary amine compound, and a xanthone compound.

[Function of Photo-Curable Composition]

A reaction scheme when the photo-curable composition according to this embodiment is cured (photo-cured) by irradiation with light, and is then subjected to heat treatment will be described with reference to FIGURE. FIGURE is a view schematically illustrating the reaction scheme when the photo-curable composition according to this embodiment is cured by irradiation with light, and is then subjected to heat treatment.

When the photo-curable composition according to this embodiment is irradiated with light (e.g., ultraviolet light) having a predetermined wavelength, the photo-radical generator (c) in the photo-curable composition generates a radical. Then, the (meth)acryloyl groups of the blocked isocyanate (a) are polymerized, and the photo-curable composition is solidified. In the case where the photo-curable composition further includes the reactive diluent (d), not only polymerization between the blocked isocyanates (a), but also polymerization between the blocked isocyanate (a) and the reactive diluent (d) proceeds. As a result of this, a photo-cured product as schematically illustrated in (b) of FIGURE is formed.

Next, when the resulting photo-cured product is subjected to heat treatment, as schematically illustrated in (c) of FIGURE, deblocking in which a blocking moiety (BL) derived from the blocking agent is eliminated proceeds, and an isocyanate group (—NCO) is regenerated. Then, the regenerated isocyanate group immediately reacts with the chain extender (b). Consequently, when the chain extender (b) has a hydroxyl group, a urethane bond is generated. When the chain extender (b) has an amino group, a urea bond is generated. As a result, a cured product as schematically illustrated in (d) of FIGURE is obtained.

In general, a cured product obtained by polymerization of (meth)acryloyl groups tends to have a high crosslinking density and low tensile strength. However, in the photo-curable composition according to this embodiment, by performing heat treatment after photo-curing, deblocking occurs as described above. Thus, the crosslinking density is decreased. Furthermore, the urethane bond or the urea bond is generated, and a cured product having a polyurethane structure, a polyurea structure, or a mixed structure thereof is generated. As a result, the cured product can have a higher tensile strength than existing cured products.

Furthermore, the photo-curable composition according to this embodiment includes the blocked isocyanate (a). As shown in the formula (3), the blocked isocyanate (a) has a polycarbonate structure including a plurality of carbonate groups (—O—(C═O)—O—) in its molecule. Accordingly, a cured product obtained by subjecting the photo-curable composition according to this embodiment which has been photo-cured to heat treatment also has the polycarbonate structure inside. Therefore, the photo-curable composition according to this embodiment can create a three-dimensional object having a high tensile strength and a high modulus of elasticity by stereolithography.

[Method for Manufacturing Three-Dimensional Object]

The photo-curable composition according to this embodiment can be suitably used for a method for manufacturing a three-dimensional object by a stereolithographic fabrication process (stereolithography). A method for manufacturing a three-dimensional object using the photo-curable composition according to this embodiment will be described below.

The method for manufacturing a three-dimensional object according to this embodiment includes a step of creating an object by stereolithography and a step of subjecting the created object to heat treatment.

<Step of Creating Object by Stereolithography>

As the stereolithography, a known method may be used. This step includes a step of curing a photo-curable composition, layer by layer, by selectively radiating an active energy ray to the photo-curable composition based on slice data of a three-dimensional object to be created.

In this step, the active energy ray to be radiated to the photo-curable composition is not particularly limited as long as the active energy ray can cure the photo-curable composition according to this embodiment. Specific examples of the active energy ray include electromagnetic waves, such as ultraviolet light, visible light, infrared light, an X-ray, a gamma ray, and a laser beam; and particle beams, such as an alpha ray, a beta ray, and an electron beam. Among these, ultraviolet light is most preferred from the viewpoint of the absorption wavelength of the photo-radical generator (c) to be used and equipment introduction cost. The exposure amount is not particularly limited, but is preferably 0.001 J/cm² or more and 10 J/cm² or less. When the exposure amount is less than 0.001 J/cm², there is a concern that the photo-curable composition may not be cured sufficiently. When the exposure amount is more than 10 J/cm², the irradiation time is prolonged, resulting in a decrease in productivity.

A method of radiating the active energy ray to the photo-curable composition is not particularly limited. For example, when light is radiated as the active energy ray, the following methods may be used. In a first method, light focused to a spot, such as laser light, is used, and two-dimensional scanning is performed on the photo-curable composition with the light. In this case, the two-dimensional scanning may be performed in point-drawing mode or line-drawing mode. A second method is a surface exposure method in which the photo-curable composition is irradiated with light in the shape of sectional data by using a projector or the like. In this case, the photo-curable composition may be irradiated with the active energy ray in a planar manner through a planar drawing mask formed by arranging a plurality of micro-optical shutters, such as liquid crystal shutters or digital micro-mirror shutters.

In this step, after the created object is obtained by stereolithography, the surface of the resulting created object may be washed with a washing agent, such as an organic solvent. Furthermore, post-curing may be performed by radiating light or heat to the resulting created object, so that an unreacted, residual component, which may remain on the surface or in the inside of the created object, can be cured. Note that, in the case where post-curing is performed by heat radiation, this step may be combined with the step of subjecting the created object to heat treatment, which will be described below.

<Step of Subjecting Created Object to Heat Treatment>

In this embodiment, by subjecting the created object obtained by stereolithography to heat treatment, as described above, deblocking is allowed to proceed so that the crosslinking density is decreased, and the urethane bond or the urea bond is generated. As a result of this, a three-dimensional object having a high tensile strength and a high modulus of elasticity is formed.

In this step, the heat treatment temperature is not particularly limited as long as deblocking of the blocking moiety in the created object proceeds, but is preferably 50° C. or higher and 200° C. or lower, and more preferably 100° C. or higher and 150° C. or lower. When the temperature is lower than 50° C., there is a possibility that deblocking does not proceed and the effect of improving toughness may not be obtained sufficiently. When the temperature is more than 200° C., there is a concern that the resin may be deteriorated and various mechanical properties of the three-dimensional object may be lowered.

In this step, the heat treatment time is not particularly limited as long as deblocking of the blocking moiety in the created object proceeds sufficiently, but is preferably 0.5 hours or more and 10 hours or less. When the heat treatment time is less than 0.5 hours, there is a possibility that deblocking does not proceed and the effect of improving toughness may not be obtained sufficiently. A heat treatment time of more than 10 hours is disadvantageous from the viewpoint of lowering of various mechanical properties of the three-dimensional object due to deterioration of the resin and productivity.

### Second Embodiment

In a second embodiment, a resin (photo-cured product) will be described.

(Photo-Cured Product)

The resin (photo-cured product) according to this embodiment is a resin in a solid state obtained by irradiating the photo-curable composition with an active energy ray, such as light having a predetermined wavelength. The resin (photo-cured product) according to this embodiment includes a repeating structural unit represented by the general formula (5):

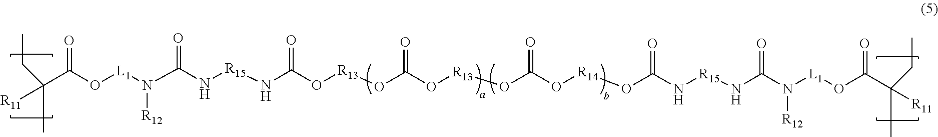

(wherein, in the formula (5), R₁₁ represents a hydrogen atom or a methyl group, R₁₂ represents a hydrocarbon group having 1 to 10 carbon atoms which may have a substituent, and L₁ represents a divalent hydrocarbon group having 1 to 10 carbon atoms; and R₁₃, R₁₄, and R₁₅ each independently represent a divalent hydrocarbon group having 1 to 20 carbon atoms which may have a substituent, a and b are integers satisfying 1≤a+b≤50, and a or b may be 0).

In the formula (5), R₁₂ is preferably a group selected from a ter-butyl group, a ter-pentyl group, and a ter-hexyl group. This is preferred because it is possible to lower the temperature (deblocking temperature) at which deblocking is performed by subjecting the photo-curable composition which has been photo-cured to heat treatment.

In the formula (5), L₁ is preferably an ethylene group or a propylene group from the viewpoint of availability and ease of synthesis.

In the formula (5), R₁₃ and R₁₄ are preferably each independently any one of the groups represented by the formulae (A-1) to (A-9) below. In this case, it is possible to increase the modulus of elasticity and tensile strength of a resin (photo- and thermally cured product) obtained by subjecting the resin (photo-cured product) according to this embodiment to heat treatment.

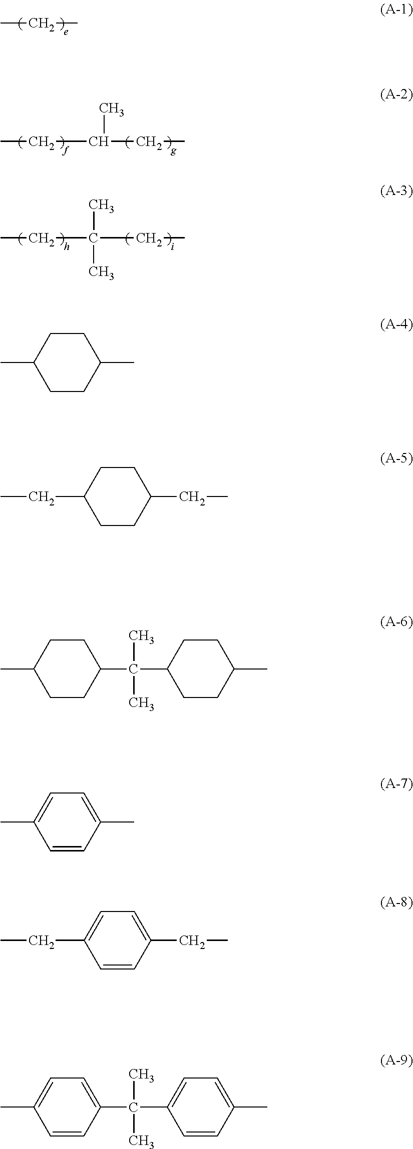

In the formula (A-1), e is an integer of 1 to 10, and in the formula (A-2), f and g are integers satisfying 1≤f+g≤10, and f or g may be 0. Furthermore, in the formula (A-3), h and i are integers satisfying 1≤h+i≤10, and h or i may be 0.

Furthermore, the resin (photo-cured product) according to this embodiment preferably includes a chain extender (b).

When the resin (photo-cured product) according to this embodiment is subjected to heat treatment to cause deblocking, the crosslinking density can be decreased. The isocyanate group regenerated by deblocking can react with the chain extender (b) in the resin to form a urethane bond or a urea bond. Then, a polyurethane or a polyuria is generated in the resin. As a result, the modulus of elasticity and tensile strength can be increased.

### Third Embodiment

In a third embodiment, a resin (photo- and thermally cured product) will be described.

(Photo- and Thermally Cured Product)

The resin (photo- and thermally cured product) according to this embodiment is a resin in a solid state obtained by subjecting the resin (photo-cured product) according to the second embodiment to heat treatment. The resin (photo- and thermally cured product) according to this embodiment includes a repeating structural unit represented by the general formula (6) below and a repeating structural unit represented by the general formula (7) below:

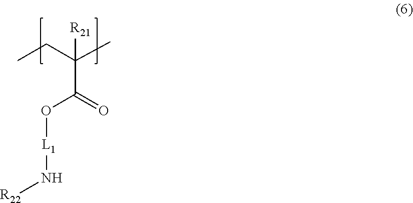

(wherein, in the formula (6), R₂₁ represents a hydrogen atom or a methyl group, R₂₂ represents a hydrocarbon group having 1 to 10 carbon atoms, and L₁ represents a divalent hydrocarbon group having 1 to 10 carbon atoms.)

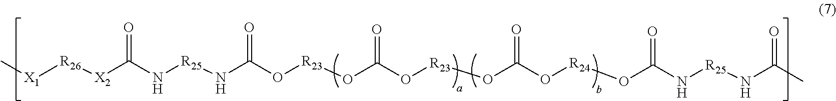

(wherein, in the formula (7), R₂₃, R₂₄, R₂₅, and R₂₆ each independently represent a divalent hydrocarbon group having 1 to 20 carbon atoms which may have a substituent, a and b are integers satisfying 1≤a+b≤50, and a or b may be 0; and X₁ and X₂ each independently represent any one of an oxygen atom (O), a sulfur atom (S), and an imino group (NH).)

(Applications)

The blocked isocyanate, the photo-curable resin, and the cured product according to this embodiment can be used in various applications, such as resins for stereolithographic fabrication, sporting goods, medical/nursing care equipment, industrial machines and equipment, precision instruments, electrical/electronic equipment, electrical/electronic components, and building materials, although not limited thereto.

### EXAMPLES

In order to explain the present invention in more detail, Examples will be shown below. However, it is to be understood that the present invention is not limited to the Examples. In each of Examples and Comparative Examples, identification of a compound, tracking of a reaction, and measurement of mechanical properties were performed by methods described below.

(Identification of Compound)

A sample in an amount of 15 mg was dissolved in 1.1 g of deuterochloroform (CDCl₃), and ¹H-NMR measurement was performed with a nuclear magnetic resonance spectrometer JNM-ECA-400 (manufactured by JEOL).

(Tracking of Reaction (Confirmation of Disappearance of Isocyanate Group))

A sample was measured by an attenuated total reflection method (ATR method) with a Fourier transform infrared spectrometer (Spectrum One manufactured by PerkinElmer, Inc.), and with absorbance being represented by the vertical axis, the presence or absence of a peak around 2,260 cm⁻¹ derived from the isocyanate group was confirmed.

(Evaluation of Mechanical Properties)

A No. 8 dumbbell-shaped test piece was obtained by punching a cured product having a thickness of about 300 μm. The tensile strength and the tensile modulus of elasticity of the test piece were measured, in accordance with JIS K 7127, with a tensile tester (trade name “Strograph EII”, manufactured by Toyo Seiki Seisaku-sho, Ltd.) at a test temperature of 23° C. and a pulling rate of 10 mm/min.

### Example 1

<Synthesis of Blocked Isocyanate 1>

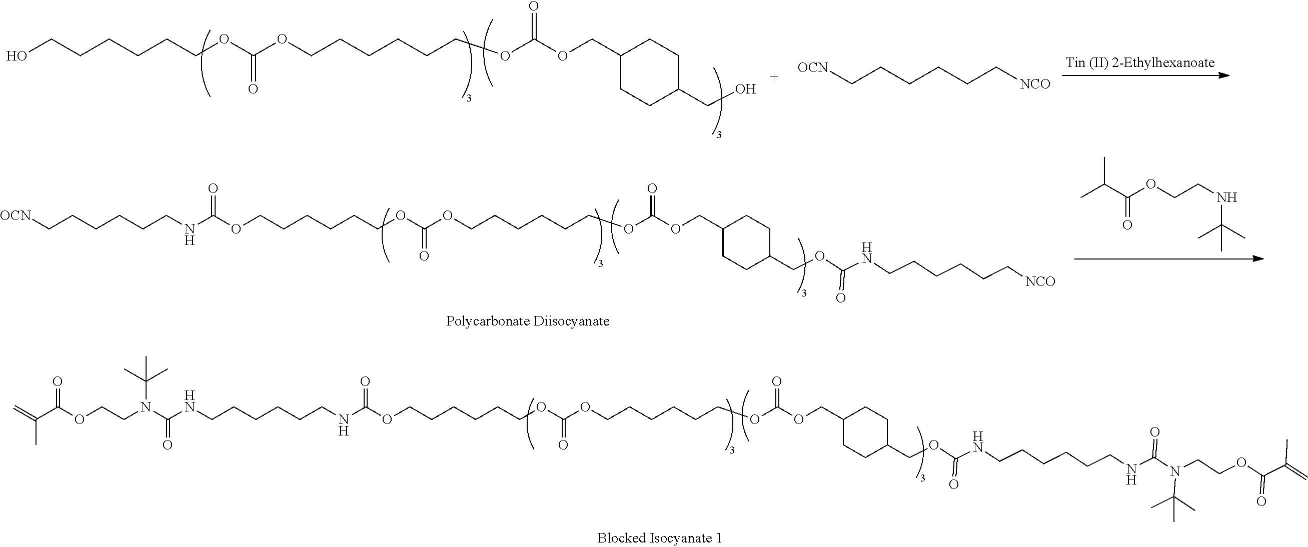

Based on the scheme described above, a blocked isocyanate 1 was synthesized. First, hexamethylene diisocyanate (168 g, 0.1 mol, 10 eq.), polycarbonate diol (ETERNACOLL UM-90 1/1) (90 g, 0.1 mol, 1.0 eq. (calculated with Mₙ=900)), and tin (II) 2-ethylhexanoate (70 μL, cat.) were added into a 300 mL reactor in an argon atmosphere at room temperature. The temperature of the resulting solution was increased to 50° C., and the solution was stirred at the same temperature for 3 hours. Then, the solution, in the warm state, was slowly added dropwise to vigorously stirred hexane (3 L). The mixture was stirred in this state for 20 minutes and then left to stand to allow precipitation, and the upper layer (hexane layer) was removed. The washing operation with hexane was further performed two times, and the resulting viscous liquid was concentrated in high vacuum. Thus, polycarbonate diisocyanate (151 g), as a colorless viscous liquid having the structure described above, was obtained.

Dichloromethane (300 mL) and hydroquinone (20 mg) were added to the polycarbonate diisocyanate thus obtained, and then, while keeping the temperature of the resulting solution at 5° C. with a cooling bath, 2-(t-butylamino)ethyl methacrylate (92.6 g, 0.5 mol, 5.0 eq.) was slowly added dropwise thereto. Then, the cooling bath was removed, and the mixture was stirred at room temperature for 14 hours. The solution was analyzed by infrared spectroscopy, and the absence of an absorption peak derived from isocyanate was confirmed by the method described above.

Next, the solution was slowly added dropwise to vigorously stirred hexane (3 L). After completion of dropwise addition, stirring was performed for 30 minutes, and the mixture was left to stand. Then, the upper layer (hexane layer) was removed through decantation, and the same operation was performed one more time. The resulting viscous liquid was dried in high vacuum at 40° C. for 6 hours, and thus, a blocked isocyanate 1 (215 g), as a colorless, very viscous liquid, was obtained.

<Preparation of Photo-Curable Composition 1>

A photo-curable composition 1 of Example 1 was prepared according to the following recipe:

Blocked Isocyanate (a):

<a-1> blocked isocyanate 1 53.3% by mass

Chain Extender (b):

<b-1> 4,4′-methylenebis(cyclohexylamine) 6.3% by mass

Reactive Diluent (d):

<d-1> isobornyl methacrylate 39.7% by mass

Photo-Radical Generator (c):

<c-1> bis(2,4,6-trimethylbenzoyl)-phenylphosphine oxide 0.7% by mass

<Production of Photo- and Thermally Cured Product 1>

The photo-curable composition 1 was poured between two quartz glass plates where a gap was formed by a spacer of 300 μm. The photo-curable composition 1 was irradiated with ultraviolet light from an ultraviolet light irradiation device (trade name “UV LIGHT SOURCE EX250”, manufactured by Hoya-Schott Corporation) at 7 mW/cm² for 120 seconds (total energy: 840 mJ/cm²), to thereby obtain a photo-cured product.

The resulting photo-cured product was placed in an oven at 125° C. and subjected to heat treatment for 4 hours, to thereby obtain a photo- and thermally cured product 1.

<Evaluation of Mechanical Properties of Photo- and Thermally Cured Product 1>

The tensile strength and the tensile modulus of elasticity of the resulting photo- and thermally cured product 1 were measured by the methods described above. The results thereof are shown in Table 1.

### Example 2

<Preparation of Photo-Curable Composition 2>

A photo-curable composition 2 of Example 2 was prepared according to the following recipe:

Blocked Isocyanate (a):

<a-1> blocked isocyanate 1 53.3% by mass

Chain Extender (b):

<b-2> 4,4′-diaminodiphenylmethane 6.3% by mass

Reactive Diluent (d):

<d-1> isobornyl methacrylate 39.7% by mass

Photo-Radical Generator (c):

<c-1> bis(2,4,6-trimethylbenzoyl)-phenylphosphine oxide 0.7% by mass

<Production of Photo- and Thermally Cured Product 2>

The photo-curable composition 2 was poured between two quartz glass plates where a gap was formed by a spacer of 300 μm. The photo-curable composition 2 was irradiated with ultraviolet light in the same manner as in Example 1, to thereby obtain a photo-cured product.

The resulting photo-cured product was placed in an oven at 125° C. and subjected to heat treatment for 4 hours, to thereby obtain a photo- and thermally cured product 2.

<Evaluation of Mechanical Properties of Cured Product 2>

The tensile strength and the modulus of elasticity of the resulting photo- and thermally cured product 2 were measured in the same manner as in Example 1. The results thereof are shown in Table 1.

### Comparative Example 1

<Synthesis of Blocked Isocyanate 2>

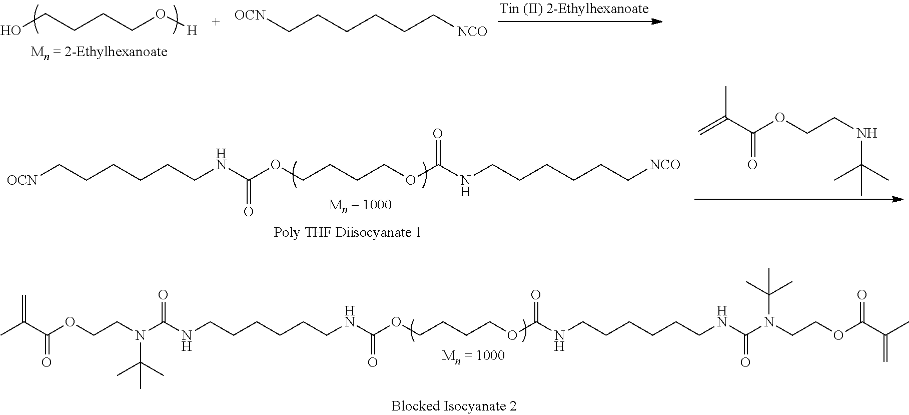

Hexamethylene diisocyanate (122 g, 720 mmol, 8.0 eq.) and tin (II) 2-ethylhexanoate (60 μL, cat.) were added into a 500 mL reactor in an argon atmosphere at room temperature. The temperature of the resulting solution was increased to 50° C., and polytetrahydrofuran (polyTHF, Mₙ=1,000) (90 g, 90 mmol, 1.0 eq.) was added dropwise thereto over about 15 minutes. The resulting solution was stirred at the same temperature for 2 hours, then left to stand to cool, and slowly added dropwise to vigorously stirred hexane (3 L). The mixture was stirred in this state for 15 minutes and then left to stand to allow precipitation, and the upper layer (hexane layer) was removed. The washing operation with hexane was performed again, and the resulting viscous liquid was concentrated in high vacuum. Thus, polyTHF diisocyanate 1 (121 g, 90.5 mmol), i.e., an intermediate, as a colorless viscous liquid, was obtained.

Dichloromethane (100 mL) and hydroquinone (0.6 mg) were added to the polyTHF diisocyanate 1. Then, 2-(t-butylamino)ethyl methacrylate (66.6 g, 360 mmol, 4.0 eq.) was slowly added dropwise thereto, and stirring was performed at 50° C. for 14 hours. IR was measured for the resulting solution, and disappearance of an absorption peak derived from isocyanate was confirmed. The solution was slowly added dropwise to vigorously stirred hexane (3 L). After completion of dropwise addition, stirring was performed for 30 minutes, and the mixture was left to stand. Then, the upper layer (hexane layer) was removed through decantation, and the same operation was performed one more time. The resulting viscous liquid was dried in high vacuum at 40° C. for 6 hours, and thus, a blocked isocyanate 2 (150 g), as a colorless viscous liquid, was obtained.

<Preparation of Photo-Curable Composition 3>

A photo-curable composition 3 of Comparative Example 1 was prepared according to the following recipe:

Blocked Isocyanate (a):

<a-2> blocked isocyanate 2 53.3% by mass

Chain Extender (b):

<b-1> 4,4′-methylenebis(cyclohexylamine) 6.3% by mass

Reactive Diluent (d):

<d-1> isobornyl methacrylate 39.7% by mass

Photo-Radical Generator (c):

<c-1> bis(2,4,6-trimethylbenzoyl)-phenylphosphine oxide 0.7% by mass

<Production of Photo- and Thermally Cured Product 3>

The photo-curable composition 3 was poured between two quartz glass plates where a gap was formed by a spacer of 300 μm. The photo-curable composition 3 was irradiated with ultraviolet light in the same manner as in Example 1, to thereby obtain a photo-cured product.

The resulting photo-cured product was placed in an oven at 125° C. and subjected to heat treatment for 4 hours, to thereby obtain a photo- and thermally cured product 3.

<Evaluation of Mechanical Properties of Photo- and Thermally Cured Product 3>

The tensile strength and the modulus of elasticity of the resulting photo- and thermally cured product 3 were measured in the same manner as in Example 1. The results thereof are shown in Table 1.

### Comparative Example 2

<Synthesis of Blocked Isocyanate 3>

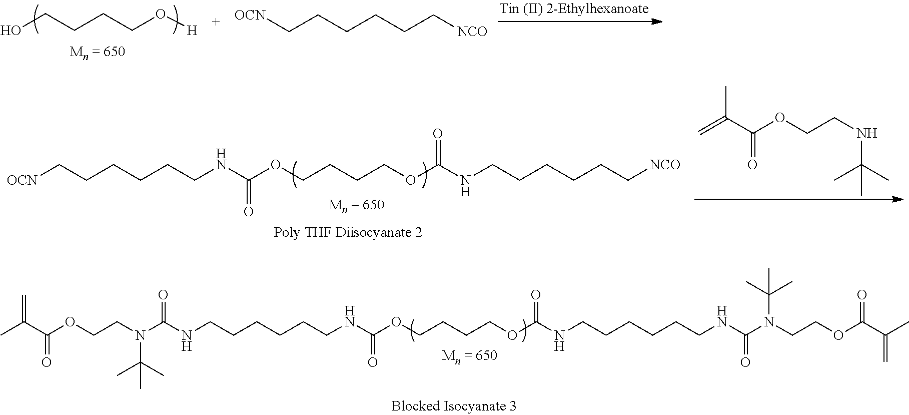

PolyTHF (Mₙ=650) (100 g, 154 mmol, 1.0 eq.) and hexamethylene diisocyanate (207 g, 1.23 mol, 1.0 eq.) were added into a 500 mL reactor in an argon atmosphere at room temperature, and stirring was performed. Tin (II) 2-ethylhexanoate (80 μL, cat.) was added to the resulting solution, the bath temperature was increased to 50° C., and stirring was performed at the same temperature for 5 hours. The reaction liquid was left to stand to cool to room temperature. This solution was added to vigorously stirred hexane (4 L), and the mixture was stirred in this state for 15 minutes and left to stand for 15 minutes. The upper layer (hexane layer) was removed through decantation. This operation was repeated two more times, and the lower layer (intermediate layer) was concentrated to thereby obtain 170 g of polyTHF diisocyanate 2.

Dichloromethane (300 mL) was added to the intermediate, and the mixture was cooled in an ice bath while being stirred. Hydroquinone (10 mg) and 2-(t-butylamino)ethyl methacrylate (142 g, 769 mmol, 5.0 eq.) were slowly added thereto, and stirring was performed at room temperature for 12 hours. Disappearance of the isocyanate group was confirmed by IR. The reaction liquid, while being stirred, was slowly added to hexane (4 L), and the mixture was stirred in this state for 20 minutes and left to stand for 20 minutes. Then, the upper layer (hexane layer) was removed through decantation. This operation was repeated three more times. The lower layer (intended substance) was subjected to Celite filtration, and then concentrated in high vacuum. Thus, a blocked isocyanate 3 (184 g), as a colorless viscous liquid, was obtained.

<Preparation of Photo-Curable Composition 4>

A photo-curable composition 4 of Comparative Example 2 was prepared according to the following recipe:

Blocked Isocyanate (a):

<a-3> blocked isocyanate 3 53.3% by mass

Chain Extender (b):

<b-1> 4,4′-methylenebis(cyclohexylamine) 6.3% by mass

Reactive Diluent (d):

<d-1> isobornyl methacrylate 39.7% by mass

Photo-Radical Generator (c):

<c-1> bis(2,4,6-trimethylbenzoyl)-phenylphosphine oxide 0.7% by mass

<Production of Photo- and Thermally Cured Product 4>

The photo-curable composition 4 was poured between two quartz glass plates where a gap was formed by a spacer of 300 μm. The photo-curable composition 4 was irradiated with ultraviolet light in the same manner as in Example 1, to thereby obtain a photo-cured product.

The resulting photo-cured product was placed in an oven at 125° C. and subjected to heat treatment for 4 hours, to thereby obtain a photo- and thermally cured product 4.

<Evaluation of Mechanical Properties of Photo- and Thermally Cured Product 4>

The tensile strength and the modulus of elasticity of the resulting photo- and thermally cured product 4 were measured in the same manner as in Example 1. The results thereof are shown in Table 1.

TABLE 1

| | | | | | Comparative | Comparative |
|---|---|---|---|---|---|---|
| | | | Example 1 | Example 2 | Example 1 | Example 2 |
| | | | Photo-curable | Photo-curable | Photo-curable | Photo-curable |
| | | | composition 1 | composition 2 | composition 3 | composition 4 |
| Composition | Blocked | a-1 | 53.3 | 53.3 | — | — |
| | isocyanate | a-2 | — | — | 53.3 | — |
| | (a) | a-3 | — | — | — | 53.3 |
| | Chain | b-1 | 6.3 | — | 6.3 | 6.3 |
| | extender (b) | b-2 | — | 6.3 | — | — |
| | Photo-radical | c-1 | 0.7 | 0.7 | 0.7 | 0.7 |
| | generator (c) | | | | | |
| | Reactive | d-1 | 39.7 | 39.7 | 39.7 | 39.7 |
| | diluent (d) | | | | | |

| | | | | | |
|---|---|---|---|---|---|
| Tensile test results | Modulus of | 1.03 | 1.04 | 0.48 | 0.75 |
| | elasticity | | | | |
| | [GPa] | | | | |
| | Tensile | 55.8 | 52.3 | 42.1 | 38.8 |
| | strength | | | | |
| | [MPa] | | | | |

<Summary of Results>

As shown in Table 1, when the photo-curable compositions of Examples 1 and 2 were used, it was possible to form photo- and thermally cured products having a higher modulus of elasticity and a higher tensile strength than the photo- and thermally cured products formed using the photo-curable compositions of Comparative Examples 1 and 2.

According to the present invention, it is possible to provide a photo-curable composition capable of creating a three-dimensional object having a high tensile strength and a high modulus of elasticity.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A photo-curable composition comprising:
a blocked isocyanate;
a chain extender; and
a photo-radical generator,
wherein the blocked isocyanate is represented by the general formula (1):
A-B-C (1)
wherein, in the formula (1), A and C each independently represent a group represented by the formula (2) below, and B represents a group represented by the formula (3) below: 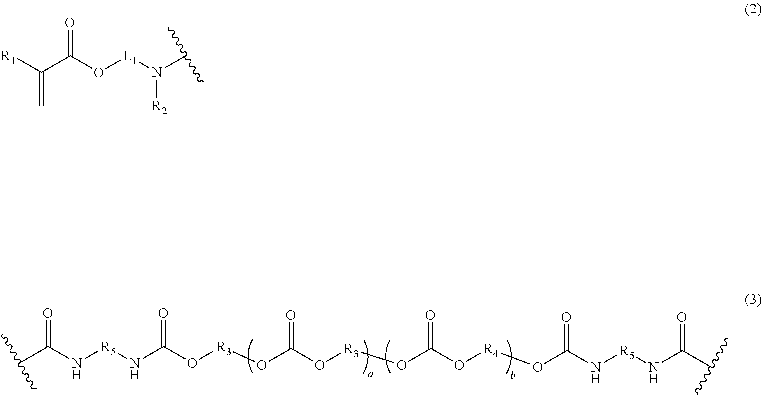
wherein, in the formula (2), R₁ represents a hydrogen atom or a methyl group, R₂ represents a hydrocarbon group having 1 to 10 carbon atoms which may have a substituent, and L₁ represents a divalent hydrocarbon group having 1 to 10 carbon atoms which may have a substituent; and in the formula (3), R₃, R₄, and R₅ each independently represent a divalent hydrocarbon group having 1 to 20 carbon atoms which may have a substituent, a and b are integers satisfying 1≤a+b≤50, and a or b may be 0.

2. The photo-curable composition according to claim 1, wherein, in the formula (2), R₂ is a group selected from a ter-butyl group, a ter-pentyl group, and a ter-hexyl group.

3. The photo-curable composition according to claim 1, wherein, in the formula (2), L₁ is an ethylene group or a propylene group.

4. The photo-curable composition according to claim 1, wherein, in the formula (3), R₃ and R₄ are each independently any one of the groups represented by the formulae (A-1) to (A-9) below: 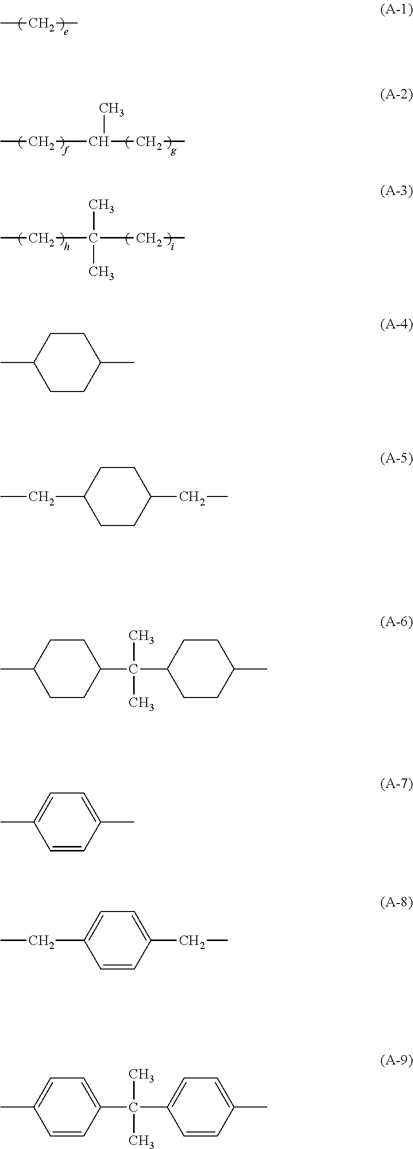
wherein, in the formula (A-1), e is an integer of 1 to 10; in the formula (A-2), f and g are integers satisfying 1≤f+g≤10, and f or g may be 0; and in the formula (A-3), h and i are integers satisfying 1≤h+i≤10, and h or i may be 0.

5. The photo-curable composition according to claim 1, wherein the blocked isocyanate is represented by the general formula (4):
A-B-A (4).

6. The photo-curable composition according to claim 1, wherein the chain extender includes a compound having, in its molecule, at least two functional groups selected from the group consisting of a hydroxyl group, an amino group, and a thiol group.

7. The photo-curable composition according to claim 1, further comprising a reactive diluent.

8. The photo-curable composition according to claim 7, wherein the reactive diluent includes a compound having an acryloyl group or a methacryloyl group.

9. The photo-curable composition according to claim 1, wherein the photo-curable composition is used for creating a three-dimensional object.

10. A resin comprising a repeating structural unit represented by the general formula (5): 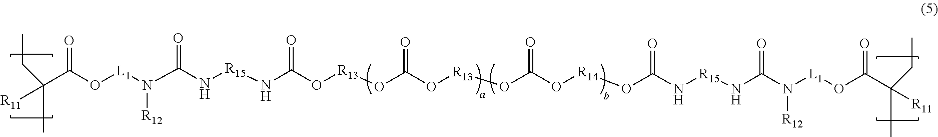
wherein, in the formula (5), R₁₁ represents a hydrogen atom or a methyl group, R₁₂ represents a hydrocarbon group having 1 to 10 carbon atoms which may have a substituent, and L₁ represents a divalent hydrocarbon group having 1 to 10 carbon atoms which may have a substituent; and R₁₃, R₁₄, and R₁₅ each independently represent a divalent hydrocarbon group having 1 to 20 carbon atoms which may have a substituent, a and b are integers satisfying 1≤a+b≤50, and a or b may be 0.

11. A resin comprising:
a repeating structural unit represented by the general formula (6): 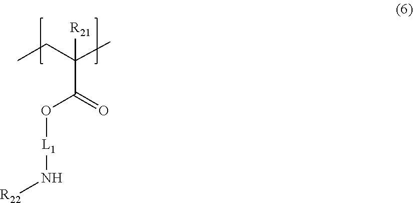
wherein, in the formula (6), R₂₁ represents a hydrogen atom or a methyl group, R₂₂ represents a hydrocarbon group having 1 to 10 carbon atoms which may have a substituent, and L₁ represents a divalent hydrocarbon group having 1 to 10 carbon atoms which may have a substituent; and
a repeating structural unit represented by the general formula (7): 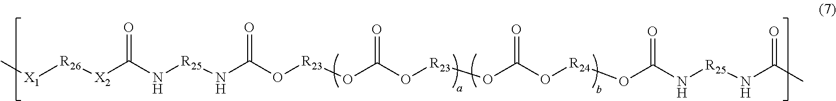
wherein, in the formula (7), R₂₃, R₂₄, R₂₅, and R₂₆ each independently represent a divalent hydrocarbon group having 1 to 20 carbon atoms which may have a substituent, a and b are integers satisfying 1≤a+b≤50, and a or b may be 0; and X₁ and X₂ each independently represent any one of an oxygen atom (O), a sulfur atom (S), and an imino group (NH).

12. A blocked isocyanate represented by the general formula (1):
A-B-C (1)
wherein, in the formula (1), A and C each independently represent a group represented by the formula (2) below, and B represents a group represented by the formula (3) below: 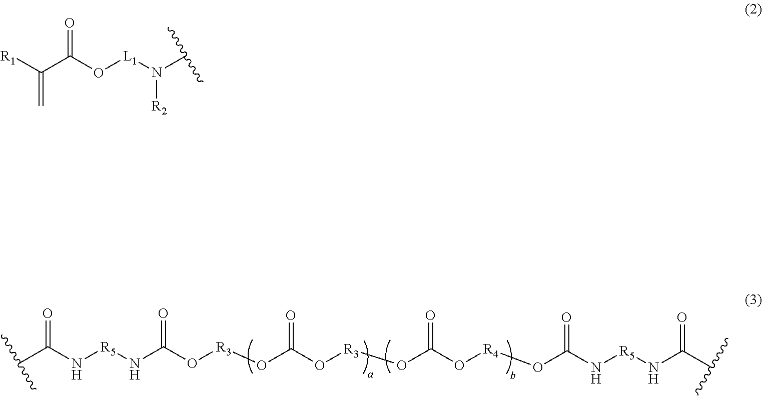
wherein, in the formula (2), R₁ represents a hydrogen atom or a methyl group, R₂ represents a hydrocarbon group having 1 to 10 carbon atoms which may have a substituent, and L₁ represents a divalent hydrocarbon group having 1 to 10 carbon atoms which may have a substituent; and in the formula (3), R₃, R₄, and R₅ each independently represent a divalent hydrocarbon group having 1 to 20 carbon atoms which may have a substituent, a and b are integers satisfying 1≤a+b≤50, and a or b may be 0.

13. A method for manufacturing a three-dimensional object comprising:
a step of creating an object by photo-curing a photo-curable composition, layer by layer, based on slice data; and
a step of obtaining a three-dimensional object by subjecting the created object to heat treatment,
wherein the photo-curable composition is the photo-curable composition according to claim 1.
